(19) United States
(12) Patent Application Publication
(10) Pub. No.: US 2007/0214044 A1
(43) Pub. Date: Sep. 13, 2007

(54) METHOD AND SYSTEM FOR ADJUSTING BALANCE OF ACCOUNT OF ADVERTISER IN KEYWORD ADVERTISEMENT

(75) Inventor: Woo Sung Lee, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/572,147

(22) PCT Filed: Jul. 15, 2005
(86) PCT No.: PCT/KR05/02275

§ 371 Date: Jan. 16, 2007

(30) Foreign Application Priority Data
Jul. 16, 2004 (KR) 10-2004-0055413

(51) Int. Cl. G06Q 30/00

(52) U.S. Cl. 705/14

(57) ABSTRACT

Disclosed are a method for adjusting the account balance of an advertiser in keyword advertising, the method comprising the steps of: maintaining an advertiser information database for storing bidding price information, minimum balance for account maintenance, and information on the account balance by each search result; generating a search result list including at least one search result associated with a predetermined keyword on the basis of the bidding price information, thereby maintaining the generated search result list in a search result database; receiving a selection of a search result from a user, with respect to the search result list provided in response to a predetermined search request including the keyword; searching for minimum balance for account maintenance and information on the account balance associated with the search result by referring to the advertiser information database, in case that the search result list is generated; increasing the number of clicks about the selected search result, only in case that the account balance searched in association with the search result is more than the minimum balance for account maintenance; computing advertising cost of a predetermined first period by using bidding price information associated with the number of accumulated clicks and the search result, after the predetermined first period elapses; subtracting the computed advertising cost from the account balance associated with the search result; and updating the advertiser information database by using information on the subtracted account balance, and a system thereof.

### CROSS REFERENCE TO RELATED APPLICATIONS

This application is a U.S. National Phase Application of International Application PCT Application No. PCT/KR2005/002275 filed on Jul. 15, 2005, which claims the benefit of priority from Korean Patent Application No. 10-2004-0055413 filed on Jul. 16, 2004. The disclosures of International Application PCT Application No. PCT/KR005/002275 and Korean Patent Application No. 10-2004-0055413 are incorporated herein by reference.

### TECHNICAL FIELD

The present invention relates to method and system for adjusting the account balance, and more particularly, to method and system for adjusting the account balance of an advertiser in keyword advertising, which enable a periodic payment to be made for advertising cost generating in association with keyword advertising service only in case that the account balance associated with a search result is maintained more than predetermined minimum balance for account maintenance, and enable a real-time payment to be made in case that the account balance associated with a search result is less than the minimum balance for account maintenance.

### BACKGROUND ART

Generally, keyword advertising service may be service providing brief information on an advertiser corresponding to a keyword to a user who has inputted the keyword in a search engine. The keyword advertising service may expose brief information on an advertiser to a user by means of a search request, and enables an access between the advertiser and the user only by the user's click with respect to the brief information. Thus, the keyword advertising service is actively being operated as efficient advertising means.

Generally, an advertiser maintains a certain amount of the account balance in a predetermined account in order to receive keyword advertising service, and prepares for advertising cost generating in accordance with exposure of brief information or a click selection of a user with respect to the exposed brief information. Namely, in case that a predetermined advertising effect associated with the advertiser occurs by the user's click with respect to brief information on the advertiser, predetermined advertising cost is charged to the advertiser and the account balance is used to pay for the charged advertising cost.

However, according to an existing method of having an advertiser pre-pay and maintain the predetermined account balance in an account and subtracting advertising cost generating according to providing of keyword advertising service from the account balance, there is a problem that an operator of the keyword advertising service and the advertiser have no accurate information on when the account balance will run out or until when keyword advertising service with respect to corresponding brief information will be provided. Namely, in the existing method, advertising cost generating at random for a certain period is generally paid in lump sum at a time point when a predetermined period ends, and an amount money to be charged as advertising cost may be more than the account balance maintained in the account. In this case, some service providers are providing service of releasing exceeding advertising cost, but it reduces advertising profits of an advertiser, thus, it cannot be said a preferable business model. Accordingly, if it is pre-estimated when the account balance runs out, and keyword advertising service of a corresponding search result is stopped or information associated with the account balance is notified to an advertiser when the account balance drops down below a predetermined amount, it may be possible to guarantee an advertiser more advertising profitability without releasing exceeding advertising cost as described above.

Accordingly, there is required a model of adjusting the account balance, which can save system resources spent in payment processing by setting a numerical value of advertising cost estimated to generate for the next period and periodically performing payment processing with respect to advertising cost only in case that the account balance is maintained more than the set numerical value.

Also, there is required a model of paying advertising cost, which can enhance advertising profitability of an advertiser by enabling advertising cost to be paid in real time in interoperation with generation of advertising cost until the account balance runs out, in case that the account balance drops down below a set numerical value.

### DISCLOSURE OF INVENTION

Technical Goals

The present invention is conceived to solve the aforementioned problems. Thus, the present invention provides method and system for adjusting the account balance, which determine minimum balance for account maintenance for each search result and guarantee a stabilized payment of advertising cost by periodically paying advertising cost according to keyword advertising service only in case that the currently maintained account balance is maintained more than the minimum balance for account maintenance.

The present invention also provides method and system for adjusting the account balance, which enhance advertising profitability by enabling a payment to be made for advertising cost in real time, in interoperation with generation of advertising cost in case that the account balance drops down below minimum balance for account maintenance and by extending a period of providing keyword advertising service to a maximum limit, and enable keyword advertising to be performed to a maximum limit in accordance with the account balance for an advertiser.

The present invention also provides method and system for adjusting the account balance, which determine the validity of a click more precisely by repeating a validity determination with respect to the click several times and enhance reliability of advertising cost charged to an advertiser by enabling flexible correction with respect to the account balance in accordance with the determination result.

Technical Solutions

According to an embodiment of the present invention for achieving the above goals, there is provided a method for adjusting the account balance of an advertiser in keyword advertising, the method including the steps of: maintaining an advertiser information database for storing bidding price information, minimum balance for account maintenance, and information on the account balance by each search result; generating a search result list including at least one search result associated with a predetermined keyword on the basis of the bidding price information, thereby maintaining the generated search result list in a search result database; receiving a selection of a search result from a user, with respect to the search result list provided in response to a predetermined search request including the keyword; searching for minimum balance for account maintenance and information on the account balance associated with the selected search result by referring to the advertiser information database; increasing the number of clicks about the selected search result, only in case that the searched account balance is more than the minimum balance for account maintenance; computing advertising cost of a predetermined first period by using bidding price information associated with the number of accumulated clicks and the search result, after the predetermined first period elapses; subtracting the computed advertising cost from the account balance associated with the search result; and updating the advertiser information database by using information on the subtracted account balance.

Also, as technical configuration for achieving the above goals, there is provided a system for adjusting the account balance of an advertiser in keyword advertising, the system including: an advertiser information database for storing bidding price information, minimum balance for account maintenance, and information on the account balance by each search result; a search result database for generating and storing a search result list including at least one search result associated with a predetermined keyword on the basis of the bidding price information; an interface unit receiving a selection of a search result from a user who has received the search result list; an account search unit searching for information on minimum balance for account maintenance and the account balance associated with the selected search result by referring to the advertiser information database; a click accumulation unit increasing the number of clicks with respect to the search result, only in case that the searched account balance is more than the minimum balance for account maintenance; advertising cost computation unit computing advertising cost of a predetermined first period by using the number of accumulated clicks and bidding price information associated with the search result, after the first period elapses; and an account updating unit subtracting the computed advertising cost from the account balance associated with the search result and updating the advertiser information database by using information on the subtracted account balance.

### BRIEF DESCRIPTION OF DRAWINGS

FIG. 1 is a view explaining schematic operations of an account balance adjustment system according to the present invention;

FIG. 2 is a configuration diagram illustrating an account balance adjustment system according to a preferred embodiment of the present invention;

FIG. 3 is a view explaining about updating advertising cost computed in association with each search result and the account balance, as an example of an advertiser information database according to the present invention;

FIG. 4 is a flowchart concretely illustrating an account balance adjustment method according to a preferred embodiment of the present invention;

FIG. 5 is a flowchart illustrating an example of a method of determining minimum balance for account maintenance according to the present invention;

FIG. 6 is a flowchart illustrating an example of a method of subtracting predetermined advertising cost in real time, in case that account balance is less than minimum balance for account balance, according to the present invention;

FIGS. 7 and 8 are flowcharts illustrating an example of a method of updating real-time data of an advertiser information database according to the present invention;

FIG. 9 is a flowchart illustrating an example of a method of performing a validity check of a click according to the present invention; and

FIG. 10 is an internal block diagram of a general-purpose computer which may be employed in implementing the account balance adjustment method according to the present invention.

### BEST MODE FOR CARRYING OUT THE INVENTION

Hereinafter, method and system for adjusting the account balance of an advertiser in keyword advertising will be described with reference to the accompanying drawings.

“Minimum balance for account maintenance” continuously used in the present specification is marginal advertising cost for a certain period that will be charged to an advertiser who receives keyword advertising service, and may indicate the minimum account balance enabling the keyword advertising service related with the advertiser to continue. That is, the minimum balance for account maintenance is determined to be advertising cost estimated to be spent for a certain period. For example, average cost charged to an advertiser for a previous predetermined period may be determined to be minimum balance for account maintenance.

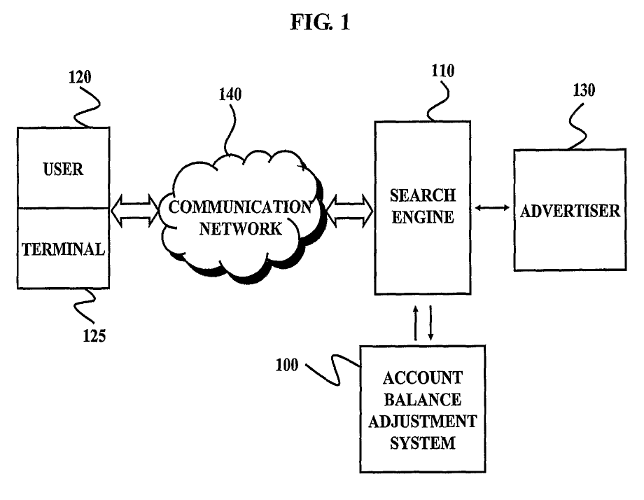

FIG. 1 is a view explaining schematic operations of an account balance adjustment system according to the present invention.

An account balance adjustment system 100 is a unit processing a payment per certain period with respect to advertising cost charged to an advertiser 130 who receives keyword advertising service, and subtracting the advertising cost from the account balance of the advertiser 130. The period at which the payment processing is performed may be flexibly determined in accordance with system environments computing and subtracting advertising cost of an advertiser with respect to keyword advertising. A payment may be enabled to be made for advertising cost per standard time unit, for example, per minute, per hour, per day, per week, per month, and the like.

First, a search engine 110 is a search program or a search web server supporting a searching operation helping an easy access to a website holding content material that a user 120 wants to search, and supports keyword advertising service embodied by the account balance adjustment system 100 of the present invention. Namely, the search engine 110 enables brief information on the advertiser 130 who can provide information demanded by the user 120 (preferably, a search result of the present invention) to be provided, in response to a search request of the user 120. Particularly, extracted brief information (a search result) includes predetermined link information, and the search engine 110 enables an access between the corresponding advertiser 130 and the user 120 who has generated a click selection, in case that a command tool click of the user with respect to brief information (a search result) displayed on a terminal 125 is generated. The search engine 110 may be classified into word-oriented searching and subject-oriented searching in accordance with an access method. In the present specification, the searching method of the search engine 110 is limited to the word-oriented searching to perform the purpose of the present invention controlling a search result extracted in correspondence to an inputted keyword to be displayed on a particular exposure location of a screen. Only, that the searching method of the search engine 110 is limited to the word-oriented searching in the present specification is only for convenience of description, and it will be apparent to those of ordinary skills in the related art that the technical spirit of the present invention is not limited thereto.

The user 120 may be an Internet user who has the terminal 125 to access the account balance adjustment system 100 of the present invention and generates a search request for a website of the advertiser 130 holding a content material that the user 120 wants to search by inputting a keyword into the search engine 110.

The advertiser 130 is, for example, a CP (Contents Provider) operating a website of which location is designated on a network by a network address (e.g., IP address, URL, domain). The advertiser 130 pays predetermined advertising cost to a system operator of the present invention as the user 120 clicks a search result of an information site associated with the advertiser 130.

The terminal 125 maintains an access sate with the account balance adjustment system 100 via a communication network 140, such as, the Internet, and displays at least one piece of search results extracted by searching of the search engine 110 on a predetermined screen. The terminal 125 may be a general concept for terminals provided with predetermined computation function by mounting a predetermined microprocessor and equipping a predetermined memory means, for example, personal computers, handheld computers, PDA (Personal Digital Assistants), MP3 players, electronic dictionaries, cellular phones, smart phones, and the like.

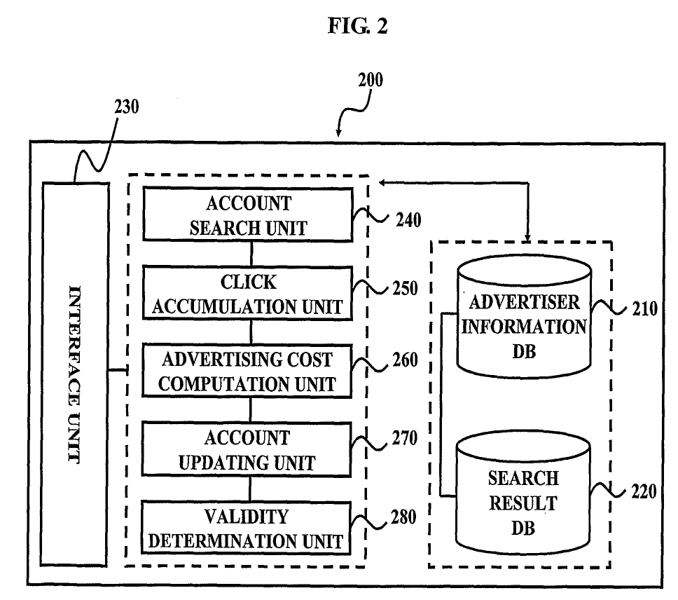

An account balance adjustment system 200 processes the payment of advertising cost generated for a certain period from a predetermined account associated with the advertiser 130, but may serve to subtract advertising cost from the account balance periodically only in case that the account balance maintained in the account is more than predetermined minimum balance for account maintenance. Through this, it is possible to prevent keyword advertising service from stopping due to a drain of money for an advertising period or to prevent this from causing loss of sales to an operator of the present system. Hereinafter, concrete configuration of the account balance adjustment system 200 will be described with reference to FIG. 2.

FIG. 2 is a configuration diagram illustrating an account balance adjustment system according to a preferred embodiment of the present invention.

The account balance adjustment system 200 of the present invention includes an advertiser information database 210, a search result database 220, an interface unit 230, an account search unit 240, a click accumulation unit 250, an advertising cost computation unit 260, an account updating unit 270, and a validity determination unit 280.

The advertiser information database 210 is a unit for storing bidding price information, minimum balance for account maintenance and information on the account balance by each search result, and stores information associated with providing of keyword advertising service corresponding to a search result. Namely, the advertiser information database 210 maintains bidding price information associated with advertising cost generating in accordance with exposure of a search result or a click thereof, the account balance from which the advertising cost is subtracted, and minimum balance for account maintenance that may be used for a standard to determine whether to continue keyword advertising of a corresponding search result, on the basis of search results. The bidding price information may be inputted at a predetermined time point when keyword advertising of a search result is registered for the first time or in accordance with an arbitrary determination of the advertiser 130. Also, the bidding price information is used in generating advertising cost in interoperation with a click of the user 120 with respect to a search result. The advertising cost may be determined through various methods by the operator of the present system considering bidding price information. Hereinafter, in the present embodiment, it will be described advertising cost that is determined, for example, by multiplying bidding price information of a corresponding search result by the total number of clicks measured with respect to a particular search result for a predetermined period. The account balance is a numerical value of an amount of money that is maintained in an account of the advertiser 130, and periodically subtracted by advertising cost generated for a predetermined period and updated in the advertiser information database 210. Also, the account balance may be updated to increase in real time by a deposit to an account of the advertiser 130. Accordingly, the advertiser information database 210 may provide information on advertising cost that has generated with respect to a particular search result and information on whether the currently maintained account balance exceeds minimum balance for account maintenance.

The search result database 220 is a unit for generating and storing a search result list including at least one search result associated with a predetermined keyword on the basis of the bidding price information. At this time, the keyword may be, for example, an identifiable substantive that causes a particular search result to be extracted in response to a search request, and the search engine 110 extracts a search result including a keyword inputted on the search engine 110 by the user 120 as a part of information. Particularly, the search engine 110 may determine each position of at least one search result to be exposed to the user 120, and provides the search result in order of the determined exposure position, thereby generating a search result list. The search result list is a list of results provided to the user 120 in response when the user 120 inputs a particular keyword to request a search, and serves to expose the extracted search results to the user 120. The exposure position of a search result on a search result list may be determined on the basis of the size of a bidding price. For example, the exposure position may be determined such that search results are sequentially provided from the highest portion of the search result list in accordance with the size of the bidding price.

The interface unit 230 is a unit for receiving a selection of a search result from the user 120 who has received a search result list. Namely, the interface unit 230 serves to receive a signal related to a click of a particular search result from the terminal 125 of the user 120. Particularly, the interface unit 230 may control the predetermined validity determination unit 280 to determine whether a generated click is valid or invalid, or invalid suspect in real time. The validity determination of a click related thereto will be described later.

The account search unit 240 is a unit for searching for minimum balance for account maintenance and information on the account balance associated with a selected search result by referring to the advertiser information database 210. Namely, the account search unit 240 serves to identify an account corresponding to a search result clicked by the user 120 and check whether the account balance maintained in the account is less than predetermined minimum balance for account maintenance.

The click accumulation unit 250 is a unit for increasing the number of clicks with respect to a search result only in case that the searched account balance is more than minimum balance for account maintenance. Namely, the click accumulation unit 250 serves to accumulate the number of clicks for each search result, in case that it is determined that an account of the advertiser 130 maintains enough money to be subtracted by advertising cost of a predetermined period. The number of clicks is accumulated for a first period determined by the operator of the present system which enables periodical payment processing of advertising cost. On the other hand, in case that the account balance associated with the search result is less than the minimum balance for account balance when the search result list is generated, the click accumulation unit 250 determines that periodical advertising cost payment processing is impossible with respect to a corresponding search result, and enables advertising cost (advertising cost-per-click) to be subtracted in real time without accumulation of the number of clicks with respect to the search result or controls the search result not to be included in the search result list when the search result list is generated.

The advertising cost computation unit 260 is a unit for computing advertising cost of a predetermined first period by using the number of accumulated clicks and bidding price information associated with a search result, after the first period elapses. At this time, the first period is a period determined by the operator of the present system, and for example, the advertising cost of a search result may be determined by multiplying a bidding price by the number of accumulated clicks generated for the first period. Namely, the advertising cost computation unit 260 computes advertising cost with respect to the number of times that the user 120 is induced to access a website of the advertiser 130 for the first period via keyword advertising service. In the present embodiment, it is described as an illustrative example that the advertising cost computation unit 260 computes advertising cost by multiplying a bidding price by the number of accumulated clicks, but it is an example of the present invention. Besides thereto, it is also possible to compute advertising cost by applying predetermined weight to the bidding price or the number of clicks. A method of computing advertising cost and weight in another embodiment may be flexibly adjusted by the operator of the present system.

Also, the advertising cost computation unit 260 may compute advertising cost-per-click that can subtract advertising cost for the selection in real time, in case that the account balance with respect to a search result included in the search result list is less than minimum balance for account maintenance with respect to the search result when the search result list is generated. Namely, in case that the computed advertising cost is estimated to be more than the account balance of the account after the first period elapses, the advertising cost computation unit 260 determines advertising cost-per-click to be subtracted from the account balance in interoperation with a click of the user 120 with respect to a search result. The advertising cost-per-click is advertising cost reducing the account balance per one-time click, and may be flexibly determined by the operator of the present system. For example, the advertising cost-per-click may be a bidding price of a corresponding search result or a bidding price applied by predetermined weight. Particularly, a payment of advertising cost by advertising cost-per-click is possible to make as far as the account balance is more than at least said advertising cost-per-click, and in case that it is not possible to subtract advertising cost anymore (e.g., a drain of the account balance), the advertising cost computation unit 260 may control keyword advertising service with respect to a corresponding search result to be stopped.

The account updating unit 270 is a unit for subtracting the computed advertising cost from the account balance associated with a search result and updating the advertiser information database 210 by using information on the subtracted account balance. Namely, the account updating unit 270 is a unit for performing payment processing for advertising cost per period of the first period with respect to a search result associated with the account balance more than the minimum balance for account maintenance, and changes the account balance that is modified by the payment processing. Also, the account updating unit 270 subtracts advertising cost-per-click from the account balance under the condition that the account balance is less than the minimum balance for account maintenance, and newly stores the changed account balance.

Thus, according to the present invention, it is possible to guarantee stable payment processing of advertising cost by periodically subtracting advertising cost associated with keyword advertising service of a predetermined period from the account balance in a sate where the account balance is maintained more than the predetermined size of minimum balance for account balance. Also, it is possible to guarantee efficient payment processing of advertising cost by making a period for adjusting the account balance identical to a period for determining whether a click is valid in case that an event such as a selection of a search result (e.g., a mouse click) occurs. Also, there is an effect that it is possible to bring more advertising profits to an operator by providing keyword advertising service according to the present invention to a maximum limit and to perform more advertising for an advertiser, even in a sate where the account balance is less than the predetermined size of minimum balance for account maintenance.

As another embodiment of the present invention, the validity determination with respect to a click of the user 120 will be described.

As described above, the account balance adjustment system 200 of the present invention may induce the user 120 to access a website associated with the advertiser 130 in accordance with a selection of a search result. At this time, a user with ill will, for example, a competitor of an advertiser who uses keyword advertising service provided in the present invention, may generate a plurality of clicks by repeatedly selecting a search result to increase advertising cost of the advertiser. Also, the repetitive selection may be automatically performed by using a predetermined command line generation program. In the present specification, a click generated by abnormal intention or processor such above is indicated as an “illegal click.” The account balance adjustment system 200 needs to protect the advertiser and enhance reliability of keyword advertising service by identifying an illegal click and guaranteeing that the advertising cost may be not subtracted from the account balance of the advertiser with respect to the illegal click. Namely, the account balance adjustment system 200 enables the advertiser 130 to pay advertising cost only with respect to a click that has brought actual advertising effects whereby it becomes possible to compute reasonable advertising cost and perform payment processing. Accordingly, a process of determining whether a selection of a search result, that is, a click is an illegal click is required.

For this, the account balance adjustment system 200 includes the validity determination unit 280 determining the validity with respect to a selection of a received search result (a click). Namely, the validity determination unit 280 determines a click of the user 120 with respect to a search result to be valid unless it is an illegal click, to be invalid if an illegal click, and to be invalid suspect if it is unclear whether it is an illegal click, and enables advertising cost to be computed only with respect to a click determined to be valid. When to perform the validity determination of the validity determination unit 280 with respect to a click may be flexibly determined by the system environment. In the present embodiment, it is described as an illustrative example that the validity determination is performed at a time point when a click selection is generated (first validity determination), at a time point when a first period ends (second validity determination), and at a time point when a predetermined second period (first period<second period) ends (third validity determination). Like above, validity/invalidity of a click may be determined more accurately by three-time validity determination for one-time click. Also, through this, computation and payment of reasonable advertising cost or correction with respect to paid advertising cost may be possible. Only, it is an example that three-time validity determination is performed with respect to one-time click, and according to embodiments, it is also possible to perform the validity determination twice or over three times.

Click validity determination by the validity determination unit 280 may be performed by using log information. For example, log information includes information on a network location of the terminal 125 receiving the selection, a time point of the selection, and the like.

For example, the validity determination unit 280 records a network address of the terminal 125 from which habitual or a plurality of invalid selections is inputted, and determines all selections from the terminal 125 having the network address to be invalid or invalid suspect. Also, in case that a click selecting a predetermined search result is continuously inputted at a certain time interval, the validity determination unit 280 determines the click to be invalid. Or, in case that clicks for selecting one search result are continuously inputted from terminals having the same network address (e.g., IP address), the validity determination unit 280 determines the click to be invalid. That is, the validity determination unit 280 may use a reasonable and objective illegal click determination standard as described above.

Also, in case that it is difficult to determine conclusively whether a particular selection is valid or invalid because a result of the validity determination with respect to the selection is within an error range, the validity determination unit 280 may determine the selection to be invalid suspect. A target and scope for the validity determination by the validity determination unit 280 may be variously applied according to the system environments. For example, in the present embodiment, it may be possible to determine each selection to be invalid, valid, or invalid suspect in the first validity determination, to determine each selection to be invalid or valid only with respect to a selection determined to be invalid suspect among selections generated for a first period in the second validity determination, and to re-perform the validity determination with respect to all selections generated for a second period in the third validity determination.

Thus, according to the present invention, it is possible to more accurately determine the validity of a click by repeating the validity determination with respect to a predetermined selection several times. Also, according to the present invention, it is possible to enhance reliability for determination by determining a validity determination result to be a determination holding, that is, invalid suspect besides valid and invalid and determining a selection to be invalid suspect in case that it is difficult to determine the selection to be valid or invalid conclusively. It is possible to re-perform the validity determination with respect to a selection determined to be invalid suspect by using collected information, and to perform the more accurate validity determination with respect to a generated selection.

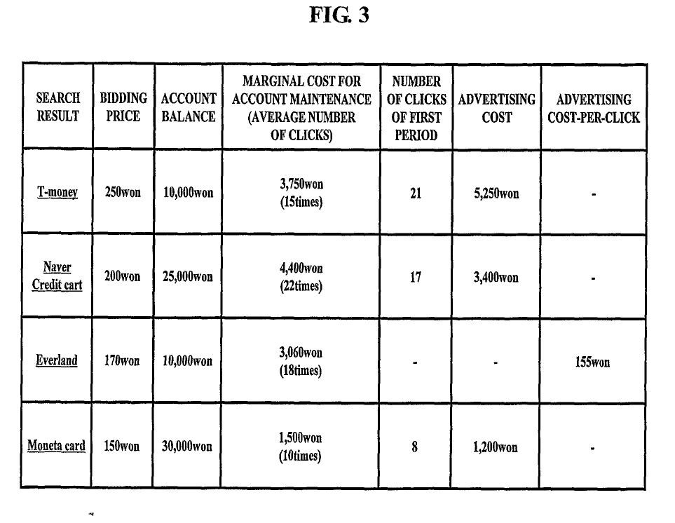

Hereinafter, adjustment of the account balance and computation of advertising cost using the account balance adjustment system 200 of the present invention will be described with reference to FIG. 3.

FIG. 3 is a view explaining about updating advertising cost computed in association with each search result and the account balance, as an example of an advertiser information database according to the present invention.

The advertiser information database 210 stores bidding price information and information on the account balance for each search result, and records information on minimum balance for account maintenance determined by predetermined computation. The account balance increases in accordance with a predetermined account balance charging signal from the advertiser 130 or decreases by subtraction of advertising cost, and the account balance is updated in real time. Minimum balance for account maintenance is computed by using the average number of clicks where a corresponding search result is selected for a first period or may be computed for each search result by using the average number of clicks and bidding price information of the search result. Namely, minimum balance for account maintenance may be determined differentially for each search result. The advertiser information database 210 of FIG. 3 shows search results provided on a search result list in correspondence to keyword ‘traffic card’.

For example, hereinafter, it is assumed that the average number of clicks per 10 minutes computed by setting a first period to be 10 minutes and counting the number of clicks with respect to search result ‘T-money’ every ten minute for a predetermined period is 15 times. In this case, the account balance adjustment system 200 may compute the advertising cost of the search result ‘T-money’ estimated to generate for 10 minutes to be ‘3,750won’ by multiplying the average number of clicks ‘15times’ by the bidding price ‘250won’. Accordingly, the computed ‘3,750won’ is advertising cost estimated to generate for 10 minutes in association with the search result ‘T-money’, and may be determined to be minimum balance for account maintenance. At this time, it is a case that advertising cost-per-click is determined to be a bidding price. The advertising cost-per-click is advertising cost charged to an advertiser per click. Also, the minimum balance for account maintenance may be computed by [minimum balance for account maintenance=average number of clicks×advertising cost-per-valid click×safety quotient, in order to stably charge advertising cost. The safety factor may be set to be 2, and the advertising cost-per-valid click is advertising cost with respect to clicks determined to be valid among clicks generating for 10 minutes.

The account balance adjustment system 200 may subtract the advertising cost of the 10 minutes with respect to a search result after the next 10 minutes elapses, only in case that a sear result list is generated and the account balance associated with the search result included in the search result list is more than minimum balance for account maintenance. Namely, the account balance adjustment system 200 allows periodical payment processing of advertising cost only with respect to a search result maintaining the account balance more than estimated advertising cost, and accumulates the number of clicks generating for the next 10 minutes. Accordingly, the search result ‘T-money’ is exposed to the user 120 in response to a search request for the next 10 minutes, and advertising cost is computed on the basis of the number of clicks of the user 120 with respect to the exposed search result ‘T-money’ that has actually generated for the next 10 minutes (21 times), and the account balance adjustment system 200 subtracts the computed advertising cost (250won×21 times=5,250won) from the account balance.

On the other hand, in case of search result ‘Everland’ of which the account balance is smaller than minimum balance for account maintenance, the account balance adjustment system 200 may determine that it is impossible to pay advertising cost estimated to generate for the next 10 minutes with the current account balance, and subtracts advertising cost in real time (processes a payment) instead of subtracting advertising cost periodically. Namely, the account balance adjustment system 200 subtracts predetermined advertising cost-per-click from the account balance in interoperation with a click selection of the search result ‘Everland’, and stops providing of keyword advertising service with respect to the search result ‘Everland’ at a time point when the account balance becomes smaller than the advertising cost-per-click. At this time, the advertising cost-per-click is advertising cost charged in accordance with one-time click of the user 120 with respect to a search result, and may be determined by referring to a bidding price stored in correspondence to the search result. For example, the advertising cost-per-click determined in FIG. 3 is a numerical value that ‘+5won’ is added to a bidding price of a search result displayed in a lower exposure position by one step, and the advertising cost-per-click of the search result ‘Everland’ may be determined to be ‘155won’ by adding ‘+5won’ to bidding price ‘150won’ of search result ‘Moneta card’. Accordingly, the search result ‘Everland’ may maintain keyword advertising service (exposure a search result) until it is generated ‘6times’ of click rendering the account balance to be smaller than the advertising cost-per-click, and may exclude an arrangement of the search result ‘Everland’ from the search result list after occurrence of the ‘6times’ of click (the final account balance of the search result ‘Everland’ is ‘70won’). In the present embodiment, computation of advertising cost-per-click and advertising cost has been described as a limited example, but there may be a plurality of methods for computing advertising cost according to system environments.

Thus, according to the present invention, it is possible to flexibly adjust a method of paying advertising cost in accordance with an amount of the account balance associated with a search result. Also, since it is possible to more precisely measure advertising cost estimated to generate for the next period by flexibly determining minimum balance for account maintenance by each search result, it is possible to subtract advertising cost in real time even when the account balance remains sufficient, or to prevent advertising cost from being subtracted periodically when the account balance remains insufficient. Also, from an advertiser's standpoint, there is an advantage that advertising is continued to a maximum limit if the account balance is more than advertising cost-per-click without removing a corresponding search result from a search result list even in case that the account balance is less than minimum balance for account maintenance. Also, from the account balance adjustment system 200's manager's standpoint, there is an advantage that it is possible to make maximum profits since advertising continues unit the account balance becomes less than advertising cost-per-click.

Operation flows of the account balance adjustment system 200 according to the present invention such constructed will be in detail described.

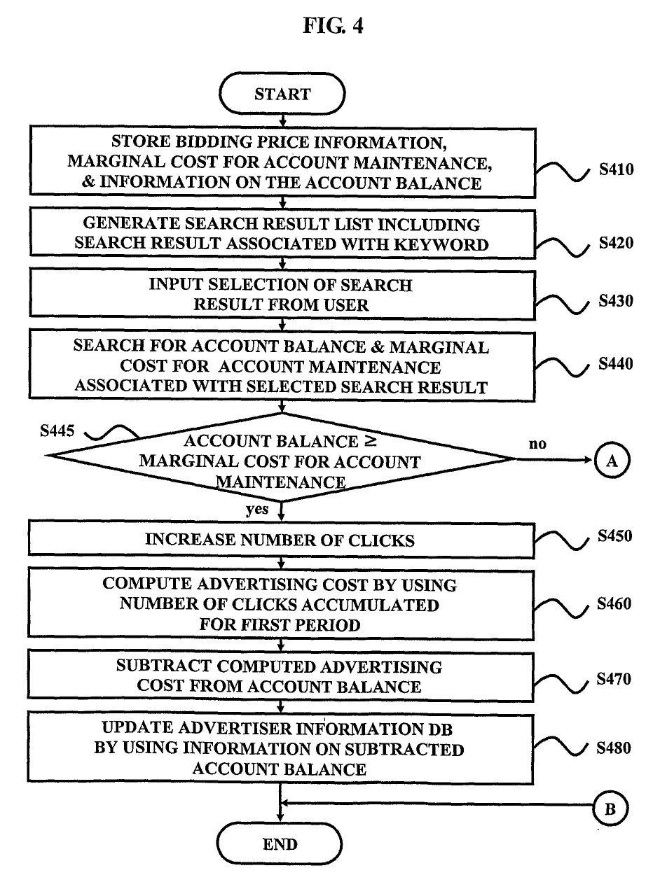

FIG. 4 is a flowchart concretely illustrating an account balance adjustment method according to a preferred embodiment of the present invention.

The account balance adjustment method of the present invention is performed by the aforementioned account balance adjustment system 200.

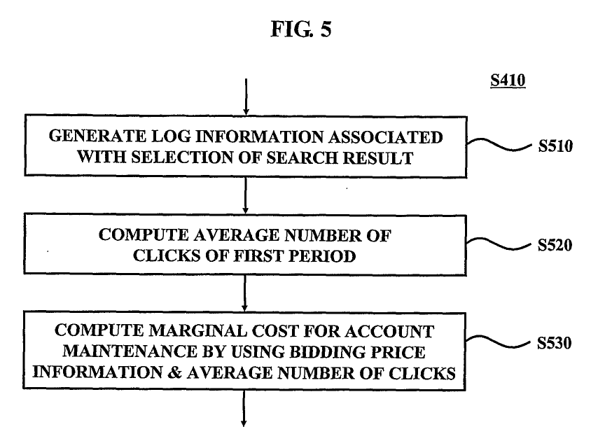

In step S410, the account balance adjustment system 200 maintains the advertiser information database 210 for storing bidding price information, and information on the account balance and minimum balance for account maintenance by each search result. This step S410 is a procedure for receiving and recording bidding price information associated with determination of an exposure position, and information on the account balance associated with subtraction of advertising cost generated by keyword advertising service with respect to each search result. Also, in this step S410, the account balance adjustment system 200 determines minimum balance for account balance with respect to each search result and stores the determined minimum balance for account balance in the advertiser information database 210. Hereinafter, minimum balance for account maintenance determined for a search result will be described with reference to FIG. 5.

FIG. 5 is a flowchart illustrating an example of a method of determining minimum balance for account maintenance according to the present invention.

As illustrated in FIG. 5, in step S510, the account balance adjustment system 200 generates log information associated with a selection of the user 120 with respect to a search result, so as to determine minimum balance for account maintenance. This step S510 is a procedure for recording log information in a predetermined log database (not illustrated), and the log information includes various information associated with a click of the user 120 with respect to a particular search result. For example, the log information includes selection time point information about a time point when a search result is selected, network information about the terminal 125 of the user 120 who has selected the search result, information for identifying the selected search result, and the like. Through the log information, the account balance adjustment system 200 may acquire time history data about a time when a click generated with respect to a particular search result, and also, recognize the number of times that a click has generated for a predetermined period.

In step S520, the account balance adjustment system 200 computes the average number of clicks that is an average of the number of clicks where a search result is selected for a first period by referring to the log information. This step S520 is a procedure for computing an average of the number of clicks that may generate for a first period on the basis of information data generated for a previous predetermined period. For example, in case that it is assumed that the first period is 10 minutes, it is possible to compute the average number of clicks per 10 minute by computing the number of selections that has generated per 10 minute for the last week on the current time point base.

In step S530, the account balance adjustment system 200 computes minimum balance for account maintenance associated with the search result by using bidding price information and the average number of clicks. This step S530 is a procedure for computing advertising cost estimated to generate for the first period. For example, the account balance adjustment system 200 may compute the minimum balance for account maintenance by multiplying the computed average number of clicks by advertising cost-per-click corresponding to the search result (see FIG. 3). In the present embodiment, it is described as an illustrative example that minimum balance for account maintenance is computed by multiplying a bidding price by the average number of clicks, but it is possible to reflect influence of various information data in computation of minimum balance for account balance by adding predetermined weight to advertising cost-per-click or the average number of clicks. For example, in case that the number of clicks is estimated to increase more than the average number of clicks due to a season factor, it is possible to substantially correct minimum balance for account maintenance by additionally applying weight over 1 to the average number of clicks with respect to a search result (e.g., ×1.2).

Thus, according to the present invention, there is an effect that it is possible to guarantee a stable payment of advertising cost by determining a numerical value of the minimum account balance to be maintained in order to continue keyword advertising service for each search result and thereby, to bring profitability to the operator of the present system.

Also, the account balance adjustment system 200 may control the steps S520 of computing the average number of clicks and S530 of computing minimum balance for account maintenance to be performed in case that bidding price information associated with a search result changes or to be periodically performed per predetermined period. Namely, the account balance adjustment system 200 generates a demand for re-computation of minimum balance for account maintenance in accordance with the passage of time or inputting of new data, and thereby may induce the computation of minimum balance for account balance flexibly reflecting the recent click trend.

Referring again to FIG. 4, in step S420, the account balance adjustment system 200 generates a search result list including at least one of search results associated with a predetermined keyword on the basis of bidding price information and maintains the generated search result list in the search result database 220. This step S420 is a procedure for providing at least one of search results extracted in response to a search request on a search result list on the basis of a predetermined exposure position. For example, in this step S420, the account balance adjustment system 200 may compare bidding prices of extracted search results and sequentially provide a search result of which the bidding price is comparatively higher in an exposure position where CTR (Click Through Rate) is more excellent. The number of exposure positions on a search result list may be determined differentially according to the environments of each system. For example, the search engine 110 extracts at least one search result including a keyword inputted for a search request as many as the number of determined exposure positions in accordance with the size of the bidding price.

In step S430, the account balance adjustment system 200 receives a selection of a search result from the user 120 with respect to a provided search result list, in response to a predetermined search request including a keyword. This step S430 is a procedure for providing a search result list to the user 120 as search result information with respect to a search request and identifying a click of the user 120 with respect to a particular search result included in the search result list. At this time, the search engine 120 enables the user 120 to access a website of the advertiser 130 by using predetermined link information of a selected search result, thereby providing information held by the advertiser 130 to the user 120. This may bring predetermined advertising effects to the user 120.

In step S440, the account balance adjustment system 200 searches for information on the account balance and minimum balance for account maintenance associated with a search result included in the search result list by referring to the advertiser information database 210, in case that the search result list is generated. This step S440 is a procedure for identifying information on an account of the advertiser 130 corresponding to a search result clicked by the user 120. In this step S440, information on the account balance currently maintained in the account of the advertiser 130 is confirmed.

In step S450, the account balance adjustment system 200 increases the number of clicks with respect to the search result only in case that the searched account balance is more than minimum balance for account maintenance. This step S450 is a procedure for comparing the account balance maintained in the account of the advertiser 130 and minimum balance for account maintenance (step S445), and determining a payment method of advertising cost differentially in accordance with a comparison result. Namely, in this step S450, the account balance adjustment system 200 accumulates the number of clicks of a corresponding search result according to a received selection when it is recognized that the account balance is maintained more than minimum balance for account maintenance, and subtracts advertising cost computed by using the number of clicks accumulated for a predetermined period (e.g., a first period) from the account balance. Through periodical subtraction of advertising cost such above, the account balance adjustment system 200 of the present invention may reduce system resources used in payment processing and perform stable payment processing of advertising cost.

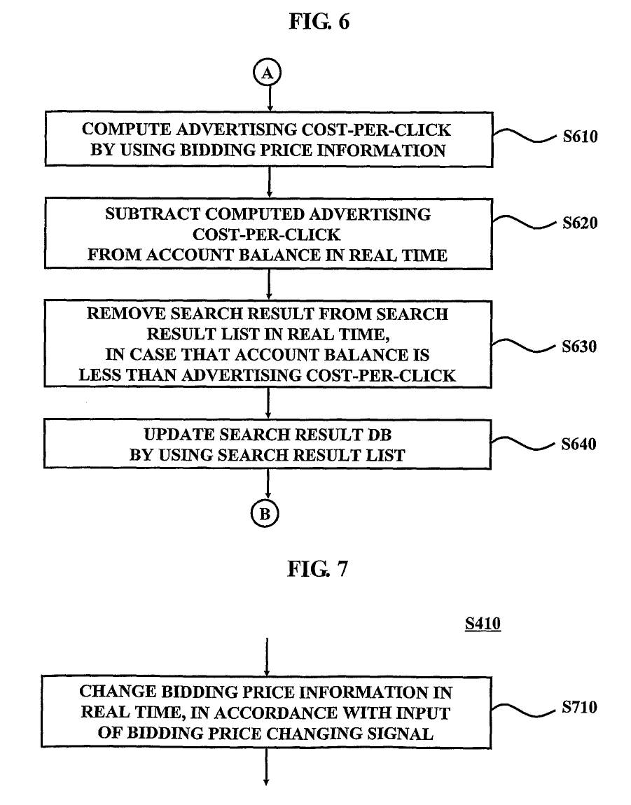

On the other hand, as a result of comparison between the account balance and minimum balance for account maintenance (S445), in case that the account balance is less than the minimum balance for account maintenance, the account balance adjustment system 200 may compute advertising cost-per-click with respect to a corresponding search result and subtract the advertising cost-per-click from the account balance in real time in interoperation with a click of the user 120. Hereinafter, real-time subtraction of advertising cost will be described with reference to FIG. 6.

FIG. 6 is a flowchart illustrating an example of a method of subtracting predetermined advertising cost in real time, in case that account balance is less than minimum balance for account balance, according to the present invention.

In step S610, the account balance adjustment system 200 computes advertising cost-per-click by using bidding price information associated with a search result selected by the user 120, in case that the account balance is less than minimum balance for account maintenance. This step S610 is a procedure for determining advertising cost to be subtracted from the account balance in real time in interoperation with a click of the user 120 with respect to a search result. Advertising cost-per-click may be flexibly determined by the operator of the present system considering bidding price information of a search result. For example, the advertising cost-per-click of a search result may be computed by adding a predetermined value (+5) to a bidding price of a search result displayed in a next-ranking exposure position (see FIG. 3).

In step S620, the account balance adjustment system 200 subtracts the computed advertising cost-per-click from the account balance associated with a search result in real time. At this time, the advertising cost-per-click may be numerical value information subtracting the account balance associated with a search result at a time, in interoperation with one-time click selection of the user 120. Namely, in this step S620, the account balance adjustment system 200 performs payment processing for the advertising cost-per-click at a time point when a click of the search result is generated, in case that estimated advertising cost of a predetermined period (first period) is determined to be insufficient.

Thus, according to the present invention, it is possible to maintain advertising effects and enhance profitability according to subtraction of advertising cost by enabling keyword advertising service with respect to a search result to be maintained for the maximum time, even in case that the account balance is maintained less than minimum balance for account maintenance.

Also, according to another embodiment of the present invention, the account balance adjustment system 200 stops keyword advertising service of a corresponding search result in case that the account balance gets too small to perform a real-time payment of advertising cost. For this, as a result of subtracting the computed advertising cost-per-click from the account balance in real time, in case that the account balance associated with the search result is less than the computed advertising cost-per-click, the account balance adjustment system 200 removes the search result from the search result list in real time in step S630. This step S630 is a procedure for comparing the account balance of an account and advertising cost-per-click and disabling an arrangement of the search result at a time point when the account balance drops down below the advertising cost-per-click. Namely, in this step S630, the account balance adjustment system 200 determines that the account balance enough to pay advertising cost generating in accordance with a click of the user 120 in real time is not maintained in the account, and stops providing of keyword advertising service. Accordingly, a search result list including the smaller number of search results than generally provided search results may be provided to a user until the next period for which a new search result list is generated.

Also, according to another embodiment of the present invention, even in case that the account balance drops down below advertising cost-per-click, if a search result list is periodically generated, the account balance adjustment system 200 may maintain the search result as it is by the next period. At this time, even in case that a search result of which the account balance is less than advertising cost-per-click is selected by a user before the next period arrives, advertising cost may not be charged for the selection since the account balance is too insufficient to make a payment even for advertising cost-per-click with respect to the search result. In the present embodiment, as far as the advertiser does not refill the account balance, although a search result list is generated, the search result is not included in the search result list.

In step S640, the account balance adjustment system 200 updates the search result database 220 by using the search result list from which the search result is removed. This step S640 is a procedure for excluding a corresponding search result of which the account balance runs out and generating a new search result list in accordance with bidding price information for the rest of search results. Accordingly, the account balance adjustment system 200 provides the new search result list to the user 120 as search result information, in response to input of a predetermined keyword later.

Thus, according to the present invention, it is possible to secure advertising profitability to a maximum limit by maintaining keyword advertising service to be provided as far as an account of the advertiser 130 has minimum ability to pay advertising cost.

Referring again to FIG. 4, in step S460, the account balance adjustment system 200 computes advertising cost of the first period by using the number of accumulated clicks and bidding price information associated with a search result, after the first period elapses. This step S460 is a procedure for computing advertising cost of the first period by multiplying the total number of clicks of a particular search result that has generated for the first period by bidding price information of the search result (see FIG. 3). In the present embodiment, a bidding price is determined to be advertising cost-per-click.

In step S470, the account balance adjustment system 200 subtracts the computed advertising cost from the account balance associated with the search result. In step S480, the account balance adjustment system 200 updates the advertiser information database 210 by using information on the subtracted account balance. These steps S470 and S480 are procedures for paying advertising cost that has generated for the first period periodically (per time point of the first period) and adjusting the account balance of an account to be a subtracted amount.

Accordingly, there is an effect that it is possible to faithfully perform the purpose of the present invention for periodically charging advertising cost for a search result under the condition that the account balance of an account is at least same to or more than minimum balance for account maintenance.

Hereinafter, as another embodiment of the present invention, it will be described that all sorts of information stored in the advertiser information database 210 is adjusted in real time in accordance with input of new data.

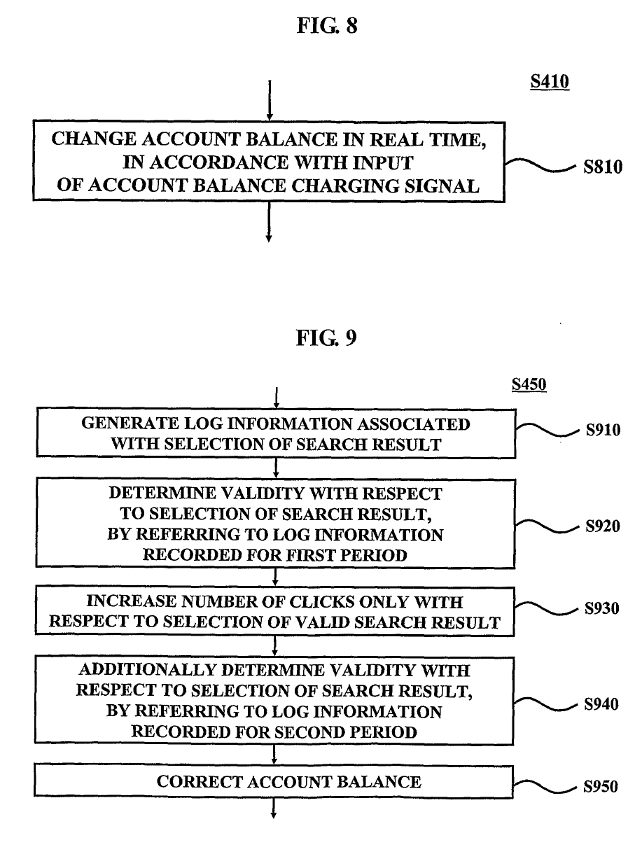

FIGS. 7 and 8 are flowcharts illustrating an example of a method of updating real-time data of an advertiser information database according to the present invention.

First, FIG. 7 shows that the advertiser information database 210 is updated as bidding price information associated with computation of advertising cost is newly inputted from the advertiser 130. For this, in case that a bidding price changing signal is inputted from the advertiser 130, the account balance adjustment system 200 changes bidding price information associated with the bidding price changing signal of the advertiser information database 210. This step S710 is a procedure for receiving a generated bidding price changing signal in case that a bidding price of a relevant search result is adjusted in accordance with the advertiser 130's arbitrary determination. The bidding price changing signal may generate, for example, in case that a search result moves an arrangement position (an exposure position) on a search result list or in case that the advertiser 130 wants to adjust advertising cost to be charged, and the account balance adjustment system 200 changes bidding price information as much as the adjusted size of the bidding price changing signal, thereby storing in the advertiser information database 210. In accordance with change of the bidding price information, a search result not included in a predetermined search result list may be included therein, or a search result included in a search result list may not be included therein, or position of the search result may be changed on the search result list. Also, in accordance with change of the bidding price information, minimum balance for account maintenance with respect to the search result and advertising cost of the first period with respect to the search result may be changed in real time or periodically.

Also, FIG. 8 shows that the size of the account balance changed through receipt of money to an account of the advertiser 130 is updated in the advertiser information database 210.

For this, in step S810, in case that an account balance charging signal is inputted, the account balance adjustment system 200 changes the account balance associated with the account balance charging signal in real time, thereby updating the advertiser information database 210. This step S810 is a procedure for increasing the size of the account balance maintained in an account in accordance with an arbitrary determination of the advertiser 130. In this step S810, the account balance is updated in accordance with information associated with the changed size included in the account balance charging signal. At this time, the account balance charging signal is generated in association with a credit card payment approval or receipt of cash to an account, and the account balance adjustment system 200 stores the changed account balance in the advertiser information database 210 in interoperation with input of the account balance charging signal.

Thus, according to the present invention, it is possible to induce a prompt updating process of data by changing information associated with computation and payment of advertising cost in real time in accordance with input of new information.

Hereinafter, the validity determination with respect to a selection (click) of the user 120 will be described with reference to FIG. 9.

FIG. 9 is a flowchart illustrating an example of a method of performing a validity check of a click according to the present invention.

The validity check with respect to a click according to the present invention may be performed in the aforementioned step S450 of increasing the number of clicks.

In step S910, the account balance adjustment system 200 generates log information associated with a selection of a search result. This step S910 is a procedure for generating predetermined record data about a search result clicked by the user 120 among search results included in a search result list. At this time, log information includes network address information about the terminal 125 of the user 120 who has inputted the search result, and selection time point information about a time point when the search result is selected. Accordingly, it becomes possible to recognize information of the user 120 who has clicked the search result and time point information about when the click has generated, from the account balance adjustment system 200 of the present invention.

In step S920, the account balance adjustment system 200 determines whether a selection of the search result is valid by referring to log information generated for a first period. This step S920 is a procedure for performing the validity determination with respect to a click by using the generated log information. In this step S920, each click is determined to be at least one of valid, invalid, or invalid suspect. For example, the account balance adjustment system 200 may determine a result of the validity determination to be invalid suspect with respect to a click generated from a network address that has generated a plurality of invalid clicks previously. In the present embodiment, it has been described as an illustrative example that the validity determination with respect to a click is performed by using network address information and time point information included in log information, but it is only an embodiment of the present invention. Besides thereto, it is also possible to perform the validity determination by considering variety of information according to system environments such as information on click frequency within a predetermined period and the like.

In step S930, the account balance adjustment system 200 increases the number of clicks only with respect to a selection of a search result determined to be valid. This step S930 is a procedure for charging advertising cost only with respect to a click that is determined to have induced the user 120 to access a website of the advertiser 130 and thereby, brought substantial advertising effects. At this time, a click determined to be invalid or invalid suspect through the validity determination is not added to the number of clicks, and charging of advertising cost is reserved. According to embodiments, it is possible to compute the total number of clicks, the number of valid clicks, and the number of invalid clicks, respectively, regardless of validity or invalidity.

Accordingly, it is possible to enable a payment of advertising cost to be more reasonable by computing advertising cost only with respect to a valid click as a result of the validity determination. Also, according to the present invention, it is possible to enable the operator of the present system to charge advertising cost immediately by enabling advertising cost to be computed per first period, for example, per comparatively short time such as 10 minutes, with respect to a valid click except clicks determined to be invalid or invalid suspect.

Also, in case that the validity determination of a click was determined to be invalid suspect in real time when the click generated, but the validity determination of the click by using log information received for the first period is valid, the click is determined to be a valid click and reflected in computing advertising cost of the first period.

Also, since a determination result of the click is re-considered through the validity determination that is performed again by further using data additionally collected for a period longer than the first period (a second period), a click with respect to a selection of the user 120 may be definitely confirmed to be valid or invalid.

In step S940, the account balance adjustment system 200 additionally determines whether a selection of the search result is valid by referring to log information generated for the second period. In this step S940, since it is determined whether a click generated for the second period exceeding the first period is an illegal click by further using log information, the validity of the click may be more accurately determined.

In step S950, in case that a result of the validity determination with respect to the first period is different from that with respect to the second period as a result of the additional determination, the account balance adjustment system 200 regards the result of the validity determination with respect to the second period as more accurate one, and corrects the account balance associated with the search result. This step S950 is a procedure for correcting the account balance in case that results determined by two or more validity determination are different to each other with respect to an identical click. Namely, in this step S950, for example, in case of a click that is determined to be valid at the initial validity determination with respect to the first period and confirmed to be invalid at the final validity determination with respect to the second period, the account balance adjustment system 200 restores advertising cost charged in association with the click and performs correction to increase the account balance. On the other hand, in case of a click that is determined to be invalid at the initial validity determination and confirmed to be valid at the final validity determination, the account balance adjustment system 200 generates predetermined advertising cost (preferably, advertising cost-per-click) in association with the valid click, and subtracts the generated advertising cost from the account balance. The correction such above is performed by a separate process from a process of subtracting advertising cost periodically per first period.

Thus, according to the present invention, there is an effect that it is possible to guarantee profits of advertising cost preferentially to the operator of the present system by charging advertising cost only with respect to a click determined to be valid at the initial validity determination. Also, in case that the determination result with respect to a click changes at the final validity determination, it is possible to prevent advertising cost from being unfairly charged by performing correction for the account balance, or to prevent the loss of a service provider providing keyword advertising service which may occur by not charging advertising cost that has to be charged.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

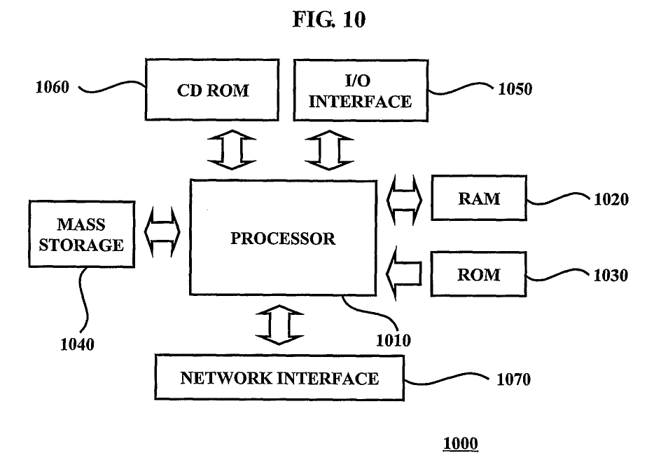

L FIG. 10 is an internal block diagram of a general-purpose computer which may be employed in implementing the account balance adjustment method according to the present invention.

The computer system 1000 includes any number of processors 1010 (also referred to as central processing units, or CPUs) that are coupled to storage devices including primary storage (typically a random access memory, or “RAM 1020”), primary storage (typically a read only memory, or “ROM 1030”). As is well known in the art, ROM 1030 acts to transfer data and instructions uni-directionally to the CPU and RAM 1020 is used typically to transfer data and instructions in a bi-directional manner. Both of these primary storage devices may include any suitable type of the computer-readable media described above. A mass storage device 1040 is also coupled bi-directionally to CPU and provides additional data storage capacity and may include any of the computer-readable media described above. The mass storage device 1040 may be used to store programs, data and the like and is typically a secondary storage medium such as a hard disk that is slower than primary storage. A specific mass storage device such as a CD-ROM 1060 may also pass data uni-directionally to the CPU. Processor 1010 is also coupled to an interface 1050 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1010 optionally may be coupled to a computer or telecommunications network using a network connection as shown generally at 1070. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

As used in this application, the term “unit” is intended to refer to, but is not limited to, a software or hardware component, which performs certain tasks. A unit or component may advantageously be configured to reside on the addressable storage medium and configured to execute on one or more processors. Thus, a unit or component may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

### INDUSTRIAL APPLICABILITY

According to the present invention, it is possible to provide method and system for adjusting the account balance, which determine minimum balance for account maintenance for each search result and guarantee a stabilized payment of advertising cost by periodically paying advertising cost according to keyword advertising service only in case that the currently maintained account balance is maintained more than the minimum balance for account maintenance.

Also, according to the present invention, it is possible to provide method and system for adjusting the account balance, which enhance advertising profitability by enabling a payment to be made for advertising cost in real time, in interoperation with generation of advertising cost in case that the account balance drops down below minimum balance for account maintenance and by extending a period of providing keyword advertising service to a maximum limit, and enable keyword advertising to be performed to a maximum limit in accordance with the account balance for an advertiser.

Also, according to the present invention, it is possible to provide method and system for adjusting the account balance, which determine the validity of a click more precisely by repeating a validity determination with respect to the click several times and enhance reliability of advertising cost charged to an advertiser by enabling flexible correction with respect to the account balance in accordance with the determination result.

1. A method for adjusting the account balance of an advertiser in keyword advertising, the method comprising the steps of:
maintaining an advertiser information database, the advertiser information database including bidding price information, minimum balance for account maintenance, and information on the account balance for at least one advertiser's account which is associated with at least one keyword and search listing of the advertiser;
receiving a search request having at least one keyword from a user;
retrieving a search result list in response to the search request from the search result database associated with the at least one keyword the search result list including at least one search listing which is associated with an advertiser's account such that the advertiser's account is charged the bid amount if the search listing is selected;
identifying minimum balance for account maintenance and information on the account balance associated with the search result by referring to the advertiser information database, in case that the search result list is retrieved;
ordering the search listings into a search result list in accordance with the bid information and the account balance; and
charging to the advertiser's account associated with the selected search listing,
wherein the advertiser's account is charged for an amount by a predetermined first period if the account balance is more than the minimum balance for account maintenance, the amount for the predetermined first period is computed by using the bidding price and the number of accumulated clicks about the selected search listing and the advertiser's account is charged for advertising cost-per-click in real time if the account balance is below the minimum balance for account maintenance and more than the advertising cost-per-click.

2. The method of claim 1, wherein the minimum balance for account maintenance is computed by performing the steps of:
a) generating log information associated with a selection of the search result, in which the log information includes selection time point information with respect to a time point when the search result is selected;
b) computing the average number of clicks which is an average of the number of clicks where the search result is selected for the first period by referring to the generated log information; and
c) computing the minimum balance for account maintenance associated with the search result by using the bidding price information and the average number of clicks.

3. The method of claim 2, wherein the steps b) and c) are performed in case that bidding price information associated with the search result changes, or performed periodically per predetermined period.

4. The method of claim 1, further comprising the steps of:
computing the advertising cost-per-click by using bidding price information associated with the search result selected by the user, in case that the account balance searched in association with the selected search result is less than the searched minimum balance for account maintenance.

5. The method of claim 1, further comprising the steps of:
removing the search result from the search result list in real time, in case that the account balance associated with the selected search result is less than the computed advertising cost-per-click as a result of subtracting the computed advertising cost-per-click in real time; and
updating the search result database by using the search result list from which the search list is removed.

6. The method of claim 1, wherein the advertising cost-per-click is numerical value information subtracting the account balance associated with the search result at a time, in interoperation with one-time click selection of a user with respect to the search result.

7. The method of claim 1, further comprising the step of:
changing bidding price information associated with a bidding price changing signal of the advertiser information database in real time, in case that the bidding price changing signal is received from an advertiser.

8. The method of claim 1, further comprising the step of:
changing the account balance associated with an account balance charging signal, thereby updating the advertiser information database, in case that the account balance charging signal is received,
wherein the account balance charging signal is generated in association with a credit card payment approval or receipt of cash.

9. The method of claim 1, wherein the step of increasing the number of clicks with respect to the search result comprises the steps of:
generating log information associated with a selection of the search result, in which the log information includes network address information with respect to a terminal of the user who has selected the search result and selection time point information with respect to a time point when the search result is selected;
determining whether a selection of the search result is valid by referring to log information generated for the first period; and
increasing the number of clicks only with respect to a selection of search results determined to be valid.

10. The method of claim 9, comprising the steps of:
additionally determining whether a selection of the search result is valid by referring to the log information generated for a predetermined second period; and
correcting the account balance associated with the search result, in case that the result of the validity determination with respect to the first period and that of the validity determination with respect to the second period are different each other as a result of additional determination;
wherein the second period is longer than the first period.

11. A method for adjusting the account balance of an advertiser in keyword advertising, the method comprising the steps of:
maintaining an advertiser information database for storing predetermined bidding price information corresponding to a search result including a predetermined keyword and information on the account balance associated with the search result;
generating a search result list including at least one search result associated with the predetermined keyword on the basis of the bidding price information, thereby maintaining the generated search result list in a search result database;
changing bidding price information associated with a predetermined bidding price changing signal of the advertiser information database in real time, in case that the bidding price changing signal is received;
periodically computing advertising cost of a first period associated with the search result by using the number of clicks that a user selects the search result and bidding price information associated with the search result from the search result list;
subtracting the computed advertising cost from the account balance associated with the search result per the first period; and
updating the advertiser information database by using information on the subtracted account balance.

12. The method of claim 11, wherein the step of generating a search result list, thereby maintaining the generated search result list in a search result database is periodically performed per a predetermined second period.

13. A computer readable record medium recording a program for implementing the method recited in claim 11.

14. A system for adjusting the account balance of an advertiser in keyword advertising, the system comprising:
an advertiser information database, the advertiser information database including bidding price information, minimum balance for account maintenance, and information on the account balance for at least one advertiser's account which is associated with at least one keyword and search listing of the advertiser;
a search result database, the search result database generating and storing a search result list including at least one search result associated with a predetermined keyword on the basis of the bidding price information;
an interface unit receiving a selection of a search result from a user who has received the search result list;
an account search unit searching for information on minimum balance for account maintenance and the account balance associated with a search result included in the search result list by referring to the advertiser information database, in case that the search result list is generated;
a click accumulation unit increasing the number of clicks with respect to the search result, only in case that the account balance searched in association with the selected search result is more than the minimum balance for account maintenance;
advertising cost computation unit computing advertising cost of a predetermined first period by using the number of accumulated clicks and bidding price information associated with the search result, after the first period elapses; and
an account updating unit subtracting the computed advertising cost from the account balance associated with the search result and updating the advertiser information database by using information on the subtracted account balance if the account balance is more than the minimum balance for account maintenance, the account updating unit subtracting the advertising cost-per-click from the account balance in response to receipt of the selection if the searched account balance is below the minimum balance and more than the advertising cost-per-click.

15. The system of claim 14, wherein:
the advertising cost computation unit computes advertising cost-per-click associated with a selection of the search result by using the bidding price information, in case that the account balance searched in association with the selected search result is less than the minimum balance for account maintenance.

16. The system of claim 14, further comprising a validity determination unit determining the validity with respect to a selection of the received search result, wherein:
the validity determination unit computes a validity determination result with respect to the selection at a time point when the selection is received and per a predetermined period, respectively, and controls the account updating unit to correct the account balance on the basis of the computed determination result.

17. A computer readable record medium recording a program for implementing the method recited in claim 1.
